(19) United States
(12) Patent Application Publication
(10) Pub. No.: US 2014/0185628 A1
(43) Pub. Date: Jul. 3, 2014

(54) DEADLINE AWARE QUEUE MANAGEMENT

(71) Applicant: BROADCOM CORPORATION, Irvine, CA (US)

(72) Inventors: Brad MATTHEWS, San Jose, CA (US); Bruce KWAN, Sunnyvale, CA (US); Puneet AGARWAL, Cupertino, CA (US)

(73) Assignee: BROADCOM CORPORATION, Irvine, CA (US)

(21) Appl. No.: 13/759,967

(22) Filed: Feb. 5, 2013

Related U.S. Application Data
(60) Provisional application No. 61/747,035, filed on Dec. 28, 2012.

(51) Int. Cl. H04L 12/56

(52) U.S. Cl. CPC H04L 47/50
USPC 370/412

(57) ABSTRACT

A method for managing data traffic operating on a deadline is provided. The method includes receiving, on an intermediate node, a packet having one or more traffic characteristics. The method also includes evaluating, on the intermediate node, the one or more traffic characteristics to determine a priority of the packet. The method also includes selecting one of multiple queues on the intermediate node based on the determined priority. The method also includes processing, on the intermediate node, the packet based on the determined priority. The method also includes enqueuing the processed packet into the selected queue. The method further includes outputting the queued packet from the selected queue.

### CROSS-REFERENCE TO RELATED APPLICATIONS

This application claims the benefit of U.S. Provisional Application No. 61/747,035, entitled “DEADLINE AWARE QUEUE MANAGEMENT,” filed Dec. 28, 2012, which is hereby incorporated by reference in its entirety for all purposes.

### BACKGROUND

Private cloud networks commonly use private application or network stacks. The information in these networks is distributed as a standard image across all endpoints/servers. Jobs, and consequently network traffic, are typically coordinated via task schedulers. Each task scheduler maps jobs to the servers or endpoints.

Datacenter networks may employ partition-aggregate schemes that operate on a deadline at each phase. In many cases, the likelihood of tasks completing before their deadline expires decreases as the required datacenter flow completion time is reduced. As such, the data flows are only useful if they meet their deadline. For example, tasks (or sub-processes) are typically required to finish before the deadline or the results are discarded.

Discarded test results, due to missed deadlines, impact potential revenue streams. Missed deadlines also limit the amount of data-mining that can be performed. Particularly, discarded flows impact the ability to generate advertisements that can be clicked by users and, therefore, impact the amount of revenue that can be generated for providers. Cloud providers, in particular, aim to maximize the number of tasks that can be completed before the associated deadlines.

Some conventional solutions for reducing network congestion in datacenter networks have proposed modifications to the TCP/IP stack or the use of explicit congestion notification (ECN) systems. Both approaches, however, mark flows for instructing them to reduce bandwidth to avoid network congestion. Furthermore, these actions are only performed at the endpoints.

### SUMMARY

An apparatus and/or method is provided for deadline aware queue management, substantially as illustrated by and/or described in connection with at least one of the figures, as set forth more completely in the claims.

### BRIEF DESCRIPTION OF THE DRAWINGS

Certain features of the subject disclosure are set forth in the appended claims. However, for purpose of explanation, several implementations of the subject disclosure are set forth in the following figures.

FIG. 1 illustrates an example network environment for deadline aware queue management in accordance with one or more implementations.

FIG. 2 illustrates an example network environment implementing a system for deadline aware queue management in accordance with one or more implementations.

FIG. 3 illustrates a flowchart of a process for deadline aware queue management in accordance with one or more implementations.

FIG. 4 illustrates a block diagram of a deadline aware queue management system using multiple routing paths in accordance with one or more implementations.

FIG. 5 illustrates a block diagram of a deadline aware queue management system using multiple queue priorities in accordance with one or more implementations.

FIG. 6 conceptually illustrates an electronic system with which any implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without one or more of these specific details. In one or more instances, structures and components are shown in block diagram form in order to avoid obscuring the concepts of the subject technology.

The subject disclosure proposes configuring network devices, such as switches or intermediate network nodes, to perform dynamic management of queues based on a state of a packet relative to an associated deadline. The subject disclosure enables cloud providers to increase their job completion rate for deadline sensitive traffic. This in effect increases data mining capabilities, which enables better targeted advertisements for increased potential revenue. The subject disclosure also avoids hardware and software changes, such as not requiring TCP stack changes in networks with a large number of server nodes (e.g., data center sites).

According to some implementations, the subject disclosure is implemented on a network device that is configured to perform a computer-implemented method for managing data traffic operating on a deadline for distributed devices. The method may include receiving, on an intermediate node, a packet having one or more traffic characteristics. The method also may include evaluating, on the intermediate node, the one or more traffic characteristics to determine a priority of the packet. The method also may include selecting one of multiple queues on the intermediate node based on the determined priority. The method also may include processing, on the intermediate node, the packet based on the determined priority. The method also may include enqueuing the processed packet into the selected queue. The method further may include outputting the queued packet from the selected queue.

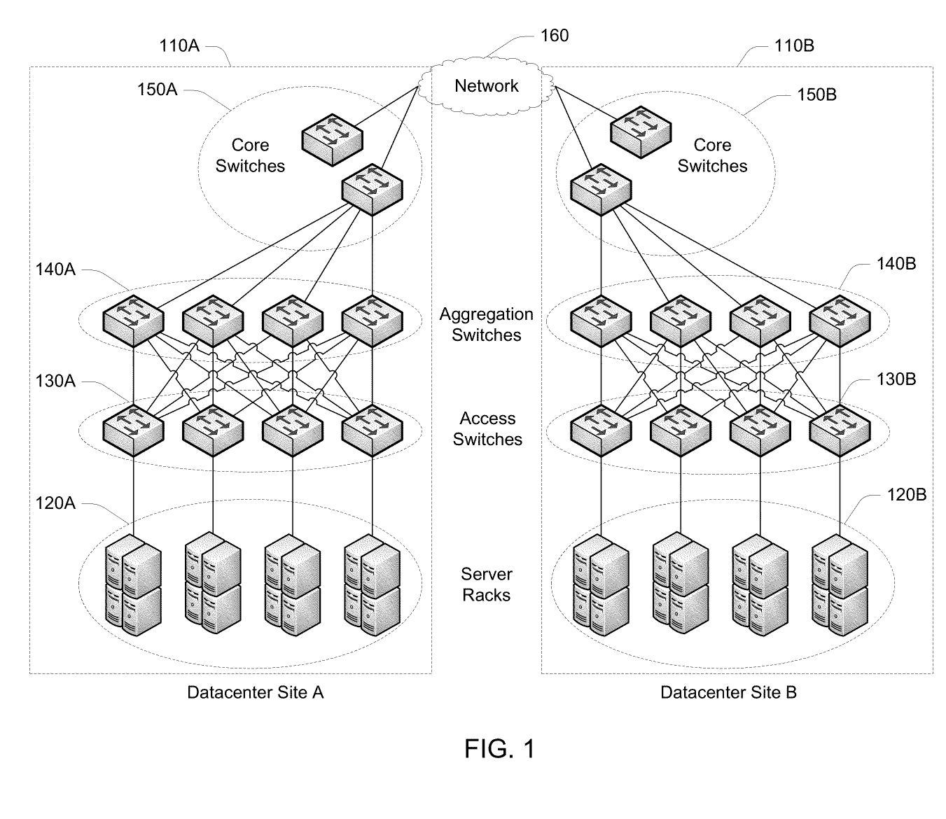

FIG. 1 illustrates a network environment 100 implementing computing systems for deadline aware queue management in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

Referring to FIG. 1, the network environment 100 includes datacenter site A 110A and datacenter center B 110B and a network 160. The datacenter sites 110A-B include server devices 120A-B, access switches 130A-B, aggregation switches 140A-B, core switches 150A-B in accordance with one or more implementations. Physical links are shown between the server devices 120A-B and access switches 130A-B respectively, and between the core switches 150A-B, the network 160, aggregation switches 140A-B, and access switches 130A-B. The relationship between the core switches 150A-B and aggregation switches 140A-B can be termed a hierarchical relationship, with the core switches 150A-B being superior. Similarly, the relationship between the aggregation switches 140A-B and access switches 130A-B can be hierarchical, where the aggregation switches 140A-B are superior.

The network environment 100 can be a subset of a data center network, and server devices 120A-B are configured to host applications and data for clients connected to the network 160. In some implementations, the teachings herein can apply to a variety of different network configurations and purposes.

The server devices 120A-B can be computer systems that have multiple processors and multiple shared or separate memory components such as, for example and without limitation, one or more computing devices incorporated in a clustered computing environment or server farm. The computing processes performed by the clustered computing environment or server farm, may be carried out across multiple processors located at the same or different locations. The server devices 120A-B can be implemented on a single computing device. Examples of computing devices include, but are not limited to, a device with a central processing unit, an application-specific integrated circuit, or other type of computing device having at least one processor and memory.

The network 160 can be any network or combination of networks, for example and without limitation, a local-area network, wide-area network, Internet, a wired connection (e.g., Ethernet) or a wireless connection (e.g., Wi-Fi, 3G, 4G, LTE) network that communicatively couples the networking components of FIG. 1 (e.g., the core switches 150A-B, the aggregation switches 140A-B, the access switches 130A-B, server devices 120A-B) to other networking components. In one or more aspects, the network 160 includes a cloud network topology.

The aggregation switches 140A-B and access switches 130A-B can be networking bridge devices with data ports that additionally have routing/switching capability, e.g., L2/L3 switch/router. The switches could have as little as two data ports or as many as 400 or more data ports, and can direct traffic in full duplex from any port to any other port, effectively making any port act as an input and any port as an output. Herein, data ports and their corresponding links can be interchangeably referred to as data channels, communication links, or data links, for ease of discussion. The aggregation switches 140A-B are configured to aggregate or truncate data gathered from one or more network nodes on the network 160. According to some implementations, the data operates on a deadline when traveling between the one or more network nodes and/or datacenter sites 110A-110B.

Because the physical depictions in the figures should not be interpreted as limiting, the access switches 130A-B and server devices 120A-B, as used herein can include server device 120A and access switch 130A combined in a single physical device (not shown). Access switches 130A-B also broadly include the use of switch logic in modem tiered switching architectures. The core switches 150A-B and aggregation switches 140A-B can be high speed switches that are placed in a network topology so as to link multiple access switches 130A-B. The term “physical,” as used herein to describe network components, typically means “non-virtual,” as in a non-virtualized device. Also, because the teachings herein as applied to traffic path selection and processing can be generally applied to all components that handle these functions, as used herein, the terms routing, switching and routing/switching are generally used interchangeably.

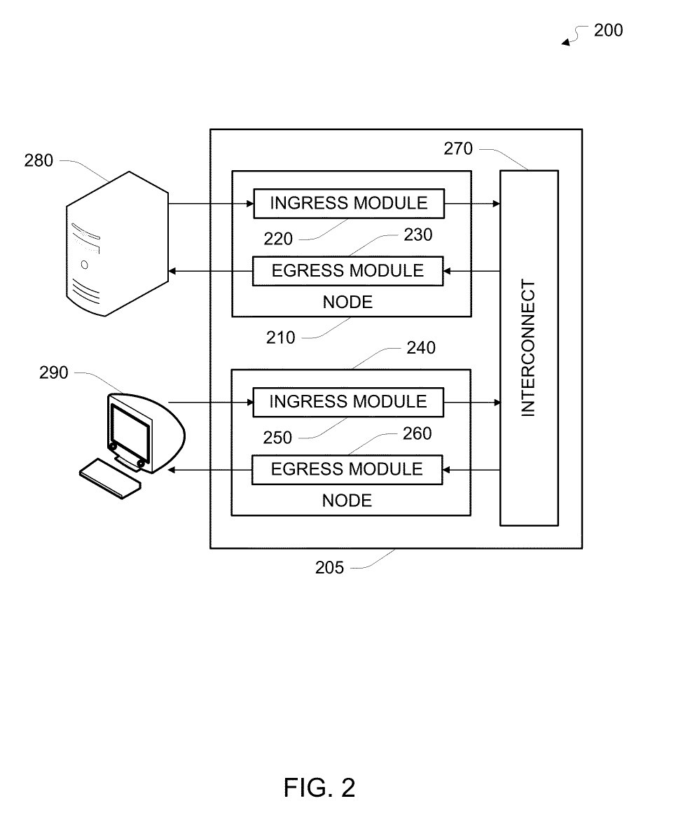

FIG. 2 illustrates an example network environment 200 implementing a system 205 for deadline aware queue management in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The network environment 200 may include various devices, such as one or more servers 280 and one or more computers 290. In one or more implementations, the network environment 200 may include a set of servers, a server bank, or a vast network of interconnected computers or network devices. In one or more implementations, the network environment 200 may include one or more other devices, such as, for example, one or more wireless telephone, mobile device or mobile phone, smart phone, communications device, tablet, personal computer (PC), set-top box (STB), personal digital assistant (PDA), palmtop computer, laptop computer, desktop computer, land-line telephone, control system, camera, scanner, facsimile machine, printer, pager, personal trusted device, web appliance, network router, switch or bridge, or any other machine or device.

One or more systems, such as the system 205, may be implemented to facilitate communication between the one or more devices of the network environment 200, such as the servers 280 and the computers 290. Any or all of the devices of the network environment 200, such as any or all of the servers 280 and the computers 290, may be connected or otherwise in communication with each other, through or using the system 205.

The system 205 includes one or more nodes 210 and 240 and an interconnect 270. The system 205 may be implemented in a network device, such as a switch device. The nodes 210 and 240, for example, can be a switch, a router, or generally any electronic device that transmits signals over a network as an intermediate node (or a node communicatively coupled between endpoints).

According to some implementations, the system 205 is implemented as one of the access switches 130A-B as discussed in FIG. 1. Accordingly, the interconnect 270 may connect to the network 160 including the aggregation switches 140A-B and core switches 150A-B as discussed in FIG. 1.

The nodes 210 and 240 include the ingress modules 220 and 250 and the egress modules 230 and 260, respectively. The nodes 210 and 240 may be on one or more dies. A die may refer to a block of semiconducting material on which a given functional or integrated circuit may be fabricated. In one or more implementations, the node 210 may represent a single die in a chip. In one or more implementations, the node 210 may represent multiple chips in a device or system, or multiple devices in a system or chassis. The system 205 may have any number of dies and the dies may have any number of the nodes 210 and 240. In one or more implementations, the ingress modules 220 and 250 and/or the egress modules 230 and 260 may represent a single logical entity in one or more dies. The nodes 210 and 240 may also be referred to as tiles. Accordingly, the ingress modules 220 and 250 may also be referred to as ingress tiles, and the egress modules 230 and 260 may also be referred to as egress tiles.

The interconnect 270 may enable communication between the ingress modules 220 and 250 and the egress modules 230 and 260. In one or more implementations, the interconnect 270 includes a fabric, such as a full mesh fabric, or any other interconnect that provides for communication between the ingress modules 220 and 250 and the egress modules 230 and 260.

The nodes 210 and 240 of the system 205 may include, or may be associated with, one or more physical ports. The ports may be internal on a single chip or die, or the ports may be spread across multiple chips or dies. One or more devices, such as the server 280 or computer 290, may connect or communicate with or through the system 205 using the one or more ports of the nodes 210 and 240. The node 210 may have two ports, such that the server 280 may connect to a first port of the node 210 and another device, such as the computer 290, may connect to the second port of the node 210. The nodes 210 and 240 of the system 205 may have, or be associated with, any number of ports. The ports may individually have a finite receive and transmit bandwidth, while the system 205 may have an aggregate bandwidth achieved by combining the bandwidth of the ports of the system 205. In one or more implementations, the system 205 includes four ports with a bandwidth of 500 gigabits per second, and therefore the system 205 may have an aggregate bandwidth of 2 terabits per second.

In one or more implementations, a port is associated with one or more classes of service, or priority levels. The classes of service may have their own separate queues for data transfers to and/or from the port. In one or more implementations, a port may have eight classes of service, or priorities, and therefore eight separate data queues; however, other variations are possible.

In the system 205, data, bits of data, a data packet, a set of data, signals, a frame (referred to as “data” or “data packet”), or a multicast frame (a frame that is intended to be transmitted to multiple destinations) may arrive at or be received at or through a physical port that may logically be referred to as an ingress port. Inbound data may be processed by the ingress modules 220 and 250 and therefore the ingress modules 220 and 250 may be referred to as being associated with one or more ingress ports. In one or more implementations, the data packets are large, and arrive and/or be processed in smaller pieces (referred to in one or more implementations as data “cells,” “segments,” “chunks,” or “portions”). The data packet may depart from the system 205 at or through a physical port that may be logically referred to as an egress port. Outbound data may be processed by the egress modules 230 and 260, and therefore the egress modules 230 and 260 may be referred to as being associated with one or more egress ports. Thus, a physical port may be logically referred to as an ingress port when data is being received at or through the port, and the same physical port may also be logically referred to as an egress port when data is being transmitted at or through the port.

The ingress modules 220 and 250 and the egress modules 230 and 260 may include one or more dedicated memories or buffers and/or may include one or more packet processors. Since the ingress modules 220 and 250 and the egress modules 230 and 260 include dedicated memories, the system 205 may not be limited by memory throughput limitations, and therefore may be highly scalable and able to provide high bandwidth aggregation.

In operation, the ingress modules 220 and 250 may transmit data to the egress modules 230 and 260 or egress ports using various data transfer techniques or switching techniques, such as a store-and-forward data transfer technique and a cut-through data transfer technique, amongst others. In the store-and-forward data transfer technique, an ingress port associated with an ingress module 220 may receive data segments of a data packet, such as data segments of a multicast frame. The ingress module 220 may store the data segments in a memory or a buffer within the ingress module 220 until the entire data packet has been received. Once the entire data packet has been received and stored in the memory of the ingress module 220, the ingress module 220 may forward the data packet to one or more egress modules 230 and 260. In the cut-through data transfer technique, an ingress port associated with the ingress module 220 may receive data segments of a data packet, such as portions of a data packet. The ingress module 220 may transmit the portions of the data packet to one or more egress modules 230 and 260 without storing the data segments, or the entire data packet, in an internal buffer or memory of the ingress module 220. The ingress module 220 may replicate the portions of the data packet, as necessary, for transmission to the egress modules 230 and 260.

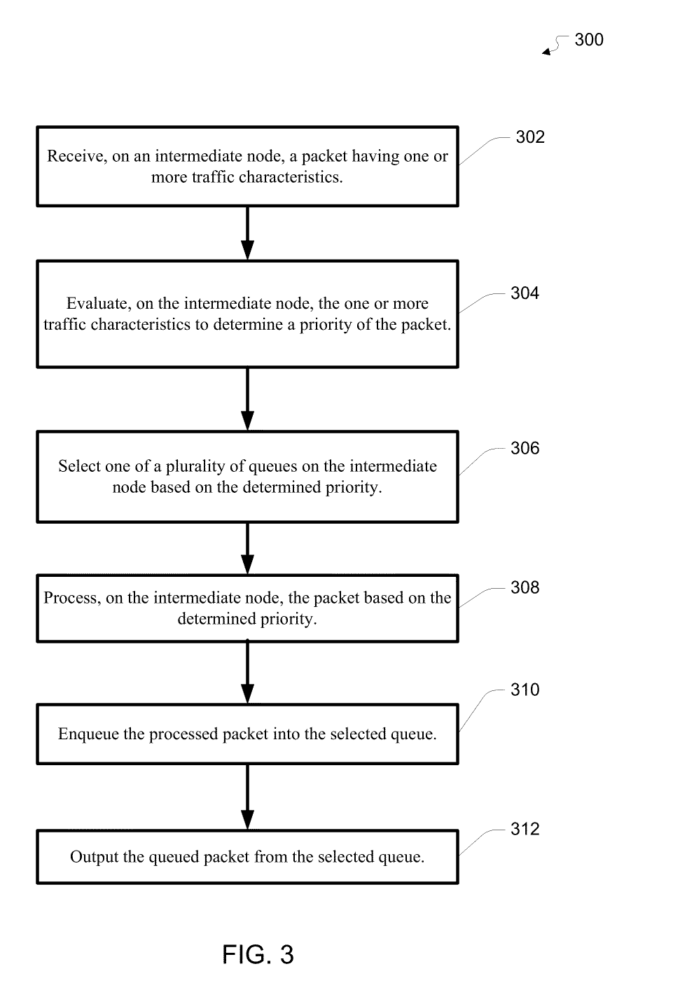

FIG. 3 illustrates a flowchart of a process 300 for deadline aware queue management system in accordance with one or more implementations. The elements of the process 300 are not limited to the order shown in FIG. 3, and can be implemented or performed in a different order that is consistent with the subject disclosure.

According to some implementations, the subject disclosure is implemented on a network device that is configured to perform a computer-implemented process 300 for managing data traffic operating on a deadline for distributed devices. The process 300 includes receiving, on an intermediate node, a packet having one or more traffic characteristics (302). The traffic characteristics can include deadline state information indicating a proximity of time between the packet to an associated deadline for the packet to reach an endpoint from the intermediate node, in which the packet is evaluated based on the deadline state information. The traffic characteristics also can include traffic type information indicating a degree of sensitivity of the packet, in which the packet is evaluated based on the traffic type information.

The process 300 also includes evaluating, on the intermediate node, the one or more traffic characteristics to determine a priority of the packet (304). In one or more aspects, determining a priority includes establishing priority if the packet has no existing priority. The policy for establishing priority may be performed on a first packet for an associated flow and maintained for all subsequent packets of the associated flow. Alternatively, establishing priority may be defined on a packet-by-packet basis. The first packet for the associated flow can be determined by measuring the time since a flow was last observed. If the time since last observance exceeds a given threshold, then the flow can be defined as a “new” flow.

In evaluating the deadline state information, the process 300 can include comparing the proximity of time with a first threshold, the first threshold indicating a difference in time between an actual time remaining and an amount of time estimated to be available. In also evaluating the deadline state information, the process 300 can include obtaining, if the proximity of time is less than the first threshold, an identifier associated with one of the queues that is configured to increase a likelihood of the packet meeting the associated deadline, in which the queue is associated with the determined priority. For example, when a received packet is determined to be in close proximity to the associated deadline than other received packets, the received packet is queued into a separate queue with a greater likelihood of the received packet meeting the associated deadline than if placed on a queue associated with a lower-priority level or a higher-latency routing path. In evaluating the traffic type information, the process 300 can include determining that the degree of sensitivity classifies the packet as deadline sensitive, in which the queue can be selected based on the packet being deadline sensitive. In also evaluating the traffic type information, the process 300 can include determining that the degree of sensitivity classifies the packet as background traffic, in which the queue can be selected based on the packet being background traffic.

The evaluating of the one or more traffic characteristics in the process 300 can include identifying a first priority level that indicates the packet with an initial priority is on-time and should not receive a change in the initial priority. The selecting also includes identifying a second priority level that indicates the packet is late and should receive a change in the initial priority to transmit the packet with a new priority that is greater than the initial priority to increase the likelihood of the packet meeting the associated deadline. The selecting further includes identifying a third priority level that indicates the packet is early and can receive a change in the initial priority to transmit the packet with a new priority that is lower than the initial priority, otherwise the packet keeps the initial priority upon transmission from the egress module.

Alternatively, the evaluating of the one or more traffic characteristics in the process 300 can include identifying a first routing path that indicates the packet, via an initial routing path with an initial latency, is on-time, the first routing path having a latency that is substantially equal to the initial routing path. The selecting also includes identifying a second routing path that indicates the packet is late and should receive a change in routing paths to transmit the packet with a latency that is lower than the initial latency to increase the likelihood of the packet meeting the associated deadline. The selecting further includes identifying a third routing path that indicates the packet is early and can receive a change in routing paths to transmit the packet with a latency that is greater than the initial latency, otherwise the packet keeps the initial routing path upon transmission from the egress module.

The process 300 also includes selecting one of a plurality of queues on the intermediate node based on the determined priority (306). The process 300 can include receiving user configuration data, in which the selecting is based on the received user configuration data.

In one or more implementations, the process 300 includes selecting one of the one or more queues of the egress module, in which each queue may be associated with one of multiple priority levels. Alternatively, the process 300 may include selecting one of the one or more queues of the egress module, in which each queue is associated with one of multiple routing paths available for the packet to traverse.

The process 300 also includes processing, on the intermediate node, the packet based on the determined priority (308). The determined priority may be an elevated priority level based on the degree of sensitivity, in which processing the packet can include processing the packet with the elevated priority level before other packets having lower priority levels are processed. In one or more implementations, the processing includes marking the packet to indicate at least one of a deadline proximity and a deadline sensitivity of the packet. The marking may be performed by storing one or more marked bits in an overhead portion of the packet. The marking also may be performed by adding control bits to the overhead portion or payload portion of the packet. The packet also may include a forwarding decision based on the determined priority to cause selection of one or more queues by one or more other nodes communicatively coupled to the intermediate node, in which the processing can include modifying the packet to include the forwarding decision. Similarly to marking the packet, the packet can be modified by adding or adjusting bits in either the overhead portion or payload portion of the packet, or both.

The process 300 also includes enqueuing the processed packet into the selected queue (310). In enqueuing the processed packet, the process 300 can include enqueuing the packet into one of multiple queues associated with a routing path based on at least one of the proximity of time and the degree of sensitivity of the traffic characteristics.

The process 300 further includes outputting the queued packet from the selected queue (312). The process 300 also can include storing the packet in the selected queue, in which the outputting can include obtaining the stored packet from the selected queue. Because the teachings herein should not be interpreted as limiting, the intermediate node may output the packet to a physical layer interface module of the intermediate node for transmission via a radio frequency signal, output to a next hop, or output to an endpoint.

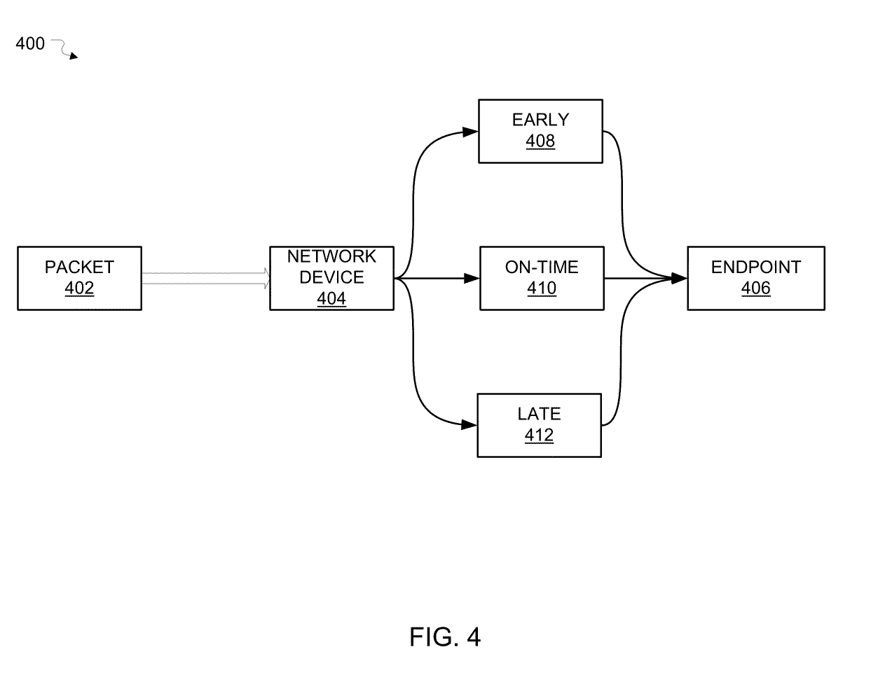

FIG. 4 illustrates a block diagram of a deadline aware queue management system 400 using multiple routing paths in accordance with one or more implementations. The deadline aware queue management system 400 includes network device 404. The network device 404, for example, can be a switch, a router, or generally any electronic device that transmits signals over a network as an intermediate node (or a node communicatively coupled between endpoints).

According to some implementations, the network device 404 is composed of an ingress module (not shown) configured to receive packet 402, in which the packet 402 can include one or more traffic characteristics. The traffic characteristics can be composed of deadline state information and/or traffic type information. The network device 404 also can be composed of an egress module (not shown) that includes one or more egress queues (not shown), in which the egress module is associated with one or more egress ports (not shown) and the egress module is communicatively coupled to the ingress module. The ingress module of the network device 404 is configured to evaluate the one or more traffic characteristics to determine a priority of the packet 402. The egress module is configured to select one of the egress queues based on the determined priority, process the packet 402 based on the determined priority, enqueue the packet 402 into the selected queue, and further configured to output the packet 402 via one of the egress ports associated with the selected queue.

According to some implementations, the one or more traffic characteristics includes deadline state information indicating a proximity of time between the packet to an associated deadline for the packet to reach an endpoint 406, in which the packet 402 is evaluated based on the deadline state information. The one or more traffic characteristics also can include traffic type information indicating a degree of sensitivity of the packet 402, in which the packet 402 is evaluated based on the traffic type information.

Because the teachings herein should not be interpreted as limiting, the evaluation of the packet 402 may be based on the deadline state information and the traffic type information, either individually or as a combination thereof, to determine the priority. As such, the packet 402 may be enqueued into a lower priority level queue even if the packet 402 is determined to be in close proximity to an associated deadline since the traffic type information classifies the packet 402 as background traffic (or low deadline sensitive). Conversely, the packet 402 may be enqueued into a higher priority level queue even if the packet 402 is classified as background traffic since the deadline state information indicates that the packet 402 is in close proximity to the associated deadline and should be routed to a faster path via an elevated priority queue or a lower-latency path.

The traffic characteristics can be evaluated to identify one or more possible combinations in determining the proper priority of the packet 402. In one or more implementations, the egress port is associated with the determined priority having a time classification (e.g., early, on-time, late). Additionally, the one or more queues may be associated with the same time classification as the corresponding egress port.

Decision to move packet 402 also may include evaluating a link state, which includes evaluating load balancing information, such as metrics associated with physical and virtual links. These metrics may include link loading, the number of packets queued to a given link or egress queue and/or link availability (e.g., whether availability is up or down).

Referring to FIG. 4, the packet 402, received at the network device 404, may be evaluated by the network device 404 to determine whether the packet 402 is on a pace to meet an associated deadline when the packet 402 reaches the endpoint 406. The packet 402 in FIG. 4 is assumed to have arrived at the network device 404 via an initial routing path with an initial latency. According to some implementations, the initial latency of the initial routing path is used by the network device 404 to measure the proximity of the packet 402 relative to an associated deadline. The measurement can be taken on-the-fly (or during initial processing of the packet 402) by the network device 404. The network device 404 can access an overhead portion of the packet 402, including reading Differentiated Service Code Point (DSCP) bits of the overhead portion. As such, one or more DSCP bits may be set to reflect a current state of the packet 402. Alternatively, the network device 404 may access user-defined tables or predefined mapping tables that enable the network device 404 to determine whether the packet 402 should have its priority level adjusted or should be routed to a lower-latency path based on a context of incoming data traffic (e.g., quality-of-service, error-rate, available bandwidth).

According to some implementations, the network device 404 modifies (or updates) routing tables based on the determination that the packet 402 should traverse a different routing path that increases the likelihood of the packet 402 meeting an associated deadline. In this regard, one or more logical modules in the network device 404 may access a data structure that stores the routing tables. The data structure may be located on the network device 404 or externally to the network device via a memory (not shown).

The multiple routing paths may be based on one or more routing strategies, including but not limited to, link aggregation (LAG) networking, equal-cost multipath (ECMP) networking, software-defined networking (SDN), Trunks networking, or any variation thereof As such, the routing tables include, but are not limited to, forwarding tables, next-hop tables, switching tables or any combination thereof that provides for tables with routing lookups (e.g., a rule set for forwarding packets).

In this regard, the packet 402 may be enqueued into a queue 408 that is associated with a routing path with a latency that is greater than the initial latency when the packet 402 is determined to have arrived with a proximity that is ahead of the associated deadline. That is, the packet 402 is determined to be an early packet and has a margin of time to reach the endpoint 406. As such, the packet 402 is placed in the queue 408 that is associated with an early routing path having a time classification of “early” to denote that the packet 402 is ahead of schedule on the initial routing path. The early routing path may be configured to have a latency that is substantially equal to or greater than that the initial latency. The level of importance for the packet to reach its destination in a timely manner can further determine the selection between keeping the same routing path or choosing a slower path to free up the faster path(s) for slower packets. In other words, packets (or data flows) that are delay sensitive (or have a high level of importance) can be routed to low-latency (or faster-route) paths. Conversely, packets that are delay insensitive (or have a low level of importance) can be routed to high-latency (or slower-route) paths.

If the network device 404 determines that the packet 402 arrived with a proximity that is close to the associated deadline and yet the packet 402 has an amount of time (or a number of hops) to reach the endpoint 406, then the packet 402 is placed into a queue 412 that is associated with a destination port having a time classification of “late” to denote the packet is running behind schedule. The queue 412 may be associated with a late routing path that is configured with a latency that is lower than the initial latency of the initial routing path in order to increase the likelihood of the packet 402 of meeting an associated deadline. As such, packets closer to their deadlines can travel on a faster routing path to meet their deadline.

In one or more implementations, the network device 404 detects the DSCP bits having been set to indicate a timestamp of the packet 402 from a prior hop or network device (e.g., server or switch). The timestamp may be a global synchronization of a certain resolution that can be set at each hop, intermediate node, or an endpoint. The timestamp may be utilized by the network device 404 to determine the proximity of the packet 402 relative to an associated deadline.

If the network device 404 determines that the packet 402 arrived with a proximity that is “on-pace” to meet the associated deadline, then the packet 402 is placed into a queue 410 that is associated with a destination port having a time classification of “on-time” to denote the packet 402 is traversing the network in accordance with the expected schedule. As such, the queue 410 can be configured to have a latency that is substantially equal to the initial routing path such that the packet 402 can resume transmission at the same rate.

According to some implementations, the selection between each of the queues 408-412 is determined using also a degree of sensitivity of the packets. That is, the sensitivity of the packet measures how important it is for the packet to meet an associated deadline. Some data flows (or data packets) may be more sensitive to missing deadlines or have a larger impact on revenue if the deadline is missed. In this regard, the network device 404 can compare the measure of sensitivity against a threshold to determine which of the three routing paths the packet 402 should traverse. In one or more implementations, the queue 412 receives the packet 402 when the measure of sensitivity (or level of importance) is greater than the threshold to denote that the packet 402 should be routed via a low-latency path so that the packet 402 has a greater likelihood of meeting an associated deadline.

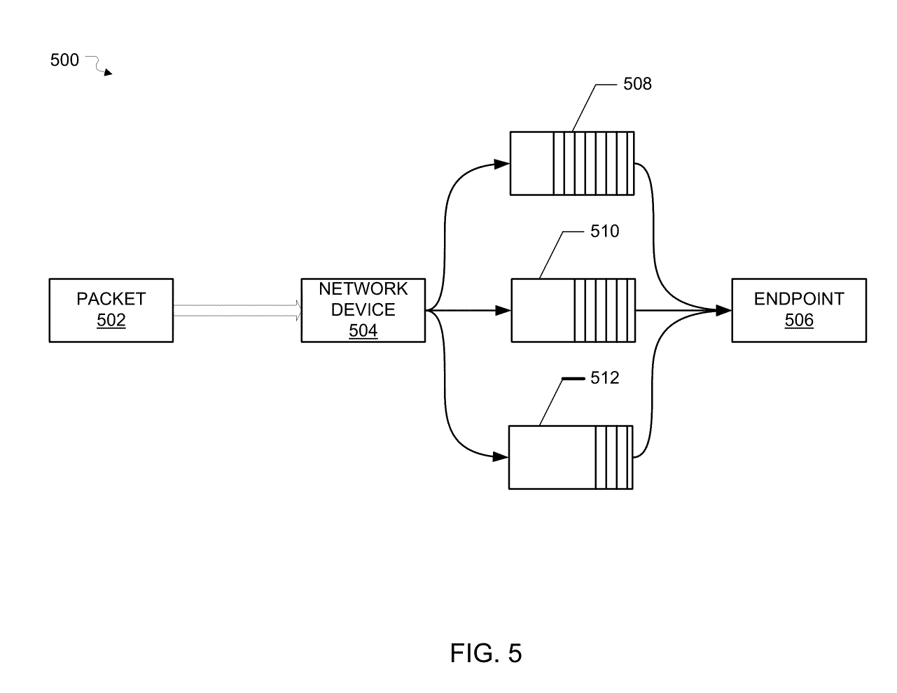

FIG. 5 illustrates a block diagram of a deadline aware queue management system 500 using multiple queue priorities in accordance with one or more implementations. In the deadline aware queue management system 500, a packet 502, received at the network device 504, may be evaluated by the network device 504 to determine whether the packet 502 is on a pace to meet an associated deadline when the packet 502 reaches the endpoint 506. The packet 502 in FIG. 5 is assumed to have arrived at the network device 504 with an initial priority via an initial routing path having an initial latency. As such, the packet 502 may be enqueued into a queue 508 that is associated with a priority level that is lower than the initial priority when the packet 502 is determined to have arrived with a proximity that is well ahead of the associated deadline. That is, the packet 502 is determined to be an early packet and has a margin of time to reach the endpoint 506. As such, the packet 502 is placed in the queue 508 that is associated with a low priority level to denote that the packet 502 is ahead of schedule.

The low priority level may be associated with a routing path that is configured to have a latency that is substantially equal to or greater than that the initial latency. The degree of sensitivity (or level of importance) for the packet to reach its destination in a timely manner can further determine the selection between keeping the same routing path or choosing a slower path to free up the higher-priority level queues for slower packets.

If the network device 504 determines that the packet 502 arrived with a proximity that is close to the associated deadline and yet the packet 502 has an amount of time (or a number of hops) to reach the endpoint 506, then the packet 502 is placed into a queue 512 that is associated with a destination port having an elevated priority level (or higher priority) to denote the packet is running behind schedule. That is, the queue 512 may be associated with a routing path that is configured with a latency that is lower than the initial latency of the initial routing path in order to increase the likelihood of the packet 502 of meeting an associated deadline. Alternatively, the queue 512 may give higher priority to transmissions carrying the packet 402 on a same routing path as other packets with lower priority levels. As such, packets closer to their deadlines can travel with higher priority and/or travel on a faster routing path to meet their deadline.

If the network device 504 determines that the packet 502 arrived with a proximity that is “on-pace” to meet the associated deadline, then the packet 502 is placed into a queue 510 that is associated with a destination port having a regular (or non-urgent) priority level to denote the packet 502 is traversing the network in accordance with the expected schedule. As such, the queue 510 is configured with a priority level that is substantially equal to the initial priority such that the packet 502 can resume transmission at the same rate.

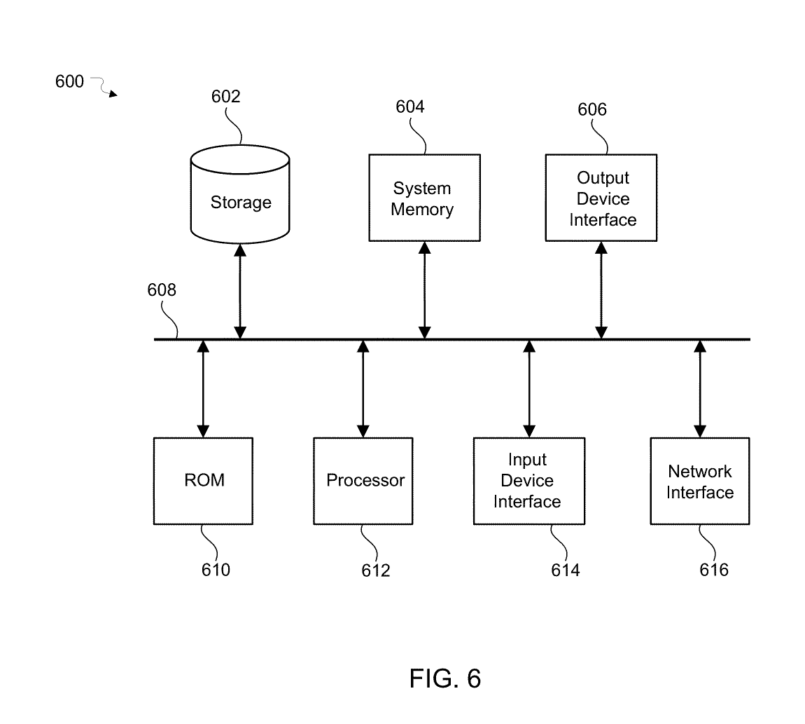

FIG. 6 conceptually illustrates electronic system 600 with which any implementations of the subject technology are implemented. Electronic system 600, for example, can be a switch, a router, or generally any electronic device that transmits signals over a network as an intermediate node (or a node communicatively coupled between endpoints). Such an electronic system includes various types of computer readable media and interfaces for various other types of computer readable media. Electronic system 600 includes bus 608, processing unit(s) 612, system memory 604, read-only memory (ROM) 610, permanent storage device 602, input device interface 614, output device interface 606, and network interface 616, or subsets and variations thereof.

According to some implementations, a non-transitory machine-readable medium embodying instructions that, when executed by a machine, cause the machine to perform a method for managing data traffic operating on a deadline for distributed devices. The non-transitory machine-readable medium can be implemented as the permanent storage device 602 or the ROM 610. The machine can be implemented as the processing unit 612. Accordingly, the processing unit 612 can perform the method that includes receiving, via the input device interface 614, a packet having one or more traffic characteristics. The processing unit 612 also can evaluate, on the intermediate node, the one or more traffic characteristics to determine a priority of the packet. The processing unit 612 also can select one of a plurality of queues on the intermediate node based on the determined priority. The processing unit 612 also can process, on the intermediate node, the packet based on the determined priority. The processing unit 612 also can cause the processed packet to be enqueued into the selected queue. The processing unit 612 can further cause the queued packet to be output from the selected queue via the output device interface 606.

Referring to FIG. 6, bus 608 collectively represents all system, peripheral, and chipset buses that communicatively connect the numerous internal devices of electronic system 600. In one or more implementations, bus 608 communicatively connects processing unit(s) 612 with ROM 610, system memory 604, and permanent storage device 602. From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. One or more implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores any of the instructions and data that processing unit(s) 612 needs at runtime. In one or more implementations, the processes of the subject disclosure are stored in system memory 604, permanent storage device 602, and/or ROM 610. From these various memory units, processing unit(s) 612 retrieves instructions to execute and data to process in order to execute the processes of one or more implementations.

Bus 608 also connects to input and output device interfaces 614 and 606. Input device interface 614 enables a user to communicate information and select commands to the electronic system. Input devices used with input device interface 614 include, for example, alphanumeric keyboards and pointing devices (also called “cursor control devices”). Output device interface 606 enables, for example, the display of images generated by electronic system 600. Output devices used with output device interface 606 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, bus 608 also couples electronic system 600 to a network (not shown) through network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of preceding a series of items, with the term “and” or “or” to separate any of the items, modifies the list as a whole, rather than each member of the list (i.e., each item). The phrase “at least one of does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method for managing data traffic, the method comprising:
receiving, on an intermediate node, a packet having one or more traffic characteristics;
evaluating, on the intermediate node, the one or more traffic characteristics to determine a priority of the packet;
selecting one of a plurality of queues on the intermediate node based on the determined priority;
processing, on the intermediate node, the packet based on the determined priority;
enqueuing the processed packet into the selected queue; and
outputting the queued packet from the selected queue.

2. The computer-implemented method of claim 1, wherein the traffic characteristics comprises deadline state information indicating a proximity of time between the packet to an associated deadline for the packet to reach an endpoint from the intermediate node, wherein the evaluating comprises evaluating the deadline state information.

3. The computer-implemented method of claim 2, wherein evaluating the deadline state information comprises comparing the proximity of time with a first threshold, the first threshold indicating a difference in time between an actual time remaining and an amount of time estimated to be available.

4. The computer-implemented method of claim 3, wherein the evaluating comprises obtaining, if the proximity of time is less than the first threshold, an identifier associated with one of the plurality of queues that is configured to increase a likelihood of the packet meeting the associated deadline, wherein the one of the plurality of queues is associated with the determined priority.

5. The computer-implemented method of claim 3, wherein the traffic characteristics comprises traffic type information indicating a degree of sensitivity of the packet, wherein the evaluating comprises evaluating the traffic type information.

6. The computer-implemented method of claim 5, wherein evaluating the traffic type information comprises determining that the degree of sensitivity classifies the packet as background traffic, wherein selecting one of the plurality of queues is based on the packet being background traffic.

7. The computer-implemented method of claim 5, wherein evaluating the traffic type information comprises determining that the degree of sensitivity classifies the packet as deadline sensitive, wherein selecting one of the plurality of queues is based on the packet being deadline sensitive.

8. The computer-implemented method of claim 5, wherein the determined priority is an elevated priority level based on the degree of sensitivity, wherein processing the packet comprises processing the packet with the elevated priority level before other packets having lower priority levels are processed.

9. The computer-implemented method of claim 5, wherein the enqueuing comprises enqueuing the packet into one of the plurality of queues associated with a routing path based on at least one of the proximity of time and the degree of sensitivity.

10. The computer-implemented method of claim 1, further comprising receiving user configuration data, wherein the selecting is based on the received user configuration data.

11. The computer-implemented method of claim 1, further comprising storing the packet in the selected queue, wherein the outputting comprises obtaining the stored packet from the selected queue.

12. The computer-implemented method of claim 1, wherein the traffic characteristics comprise an indication of a plurality of priority levels, wherein evaluating the one or more traffic characteristics comprises:
identifying a first priority level of the plurality of priority levels that indicates the packet, with an initial priority, is on-time and should not receive a change in the initial priority;
identifying a second priority level of the plurality of priority levels that indicates the packet is late and should receive a change in the initial priority to transmit the packet with a new priority that is greater than the initial priority to increase a likelihood of the packet meeting the associated deadline; and
identifying a third priority level of the plurality of priority levels that indicates the packet is early and can receive a change in the initial priority to transmit the packet with a new priority that is lower than the initial priority, otherwise the packet is transmitted with the initial priority.

13. The computer-implemented method of claim 1, wherein the traffic characteristics comprise an indication of a plurality of routing paths, wherein evaluating the one or more traffic characteristics comprises:
identifying a first routing path of the plurality of routing paths that associates the packet, received via an initial routing path having an initial latency, with an indication that the packet is on-time, the first routing path having a latency that is substantially equal to the initial routing path;
identifying a second routing path of the plurality of routing paths that associates the packet with an indication that the packet is late and should receive a change in routing paths to transmit the packet via the second routing path having a latency that is lower than the initial latency to increase a likelihood of the packet meeting the associated deadline; and
identifying a third routing path of the plurality of routing paths that associates the packet with an indication that the packet is early and the packet can receive a change in routing paths to transmit the packet via the third routing path having a latency that is greater than the initial latency, otherwise the packet is transmitted via the initial routing path.

14. The computer-implemented method of claim 1, wherein the processing comprises marking the packet to indicate at least one of a deadline proximity and a deadline sensitivity of the packet.

15. The computer-implemented method of claim 1, wherein the packet comprises a forwarding decision based on the determined priority to cause selection of one or more queues by one or more other nodes communicatively coupled to the intermediate node, wherein the processing comprises modifying the packet to include the forwarding decision.

16. The computer-implemented method of claim 1, wherein evaluating the one or more traffic characteristics comprises:
obtaining link state information associated with the packet, wherein the link state information comprises an indication of link loading, a number of packets queued and availability; and
evaluating the link state information to establish priority of the packet.

17. A system for managing data traffic operating on a deadline for distributed devices, the system comprising:
an ingress module configured to receive a packet having one or more traffic characteristics and evaluate the one or more traffic characteristics to determine a priority of the packet; and
an egress module comprising a plurality of egress queues, wherein the egress module is associated with a plurality of egress ports and the egress module is communicatively coupled to the ingress module,
wherein the egress module is configured to select one of the plurality of egress queues based on the determined priority, process the packet based on the determined priority, enqueue the processed packet into the selected queue, and further configured to output the queued packet via one of the plurality of egress ports associated with the selected queue.

18. The system of claim 17, wherein the one or more traffic characteristics comprises:
deadline state information indicating a proximity of time between the packet to an associated deadline for the packet to reach an endpoint; and
traffic type information indicating a degree of sensitivity of the received packet, wherein the packet is evaluated based on the deadline state information and the traffic type information.

19. A non-transitory machine-readable medium embodying instructions that, when executed by a machine, cause the machine to perform a method for managing data traffic, the method comprising:
receiving, on an intermediate node, a packet having one or more traffic characteristics;
evaluating, on the intermediate node, the one or more traffic characteristics to determine a priority of the packet;
selecting one of a plurality of queues on the intermediate node based on the determined priority;
processing, on the intermediate node, the packet based on the determined priority;
enqueuing the processed packet into the selected queue; and
outputting the queued packet from the selected queue.

20. The non-transitory machine-readable medium of claim 19, wherein the one or more traffic characteristics comprises:
deadline state information indicating a proximity of time between the packet to an associated deadline for the packet to reach an endpoint; and
traffic type information indicating a degree of sensitivity of the received packet, wherein the packet is evaluated based on the deadline state information and the traffic type information.
